(19) United States
(12) Patent Application Publication
(10) Pub. No.: US 2019/0116030 A1
(43) Pub. Date: Apr. 18, 2019

(54) STORING DATA FOR RANSOMWARE RECOVERY

(71) Applicant: Chronicle LLC, Mountain View, CA (US)

(72) Inventor: Michael Wiacek, Mountain View, CA (US)

(21) Appl. No.: 15/785,078

(22) Filed: Oct. 16, 2017

(51) Int. Cl. H04L 9/08; H04L 9/14; H04L 29/06

(52) U.S. Cl. CPC H04L 9/0894; H04L 63/145; H04L 9/14; H04L 9/0861

(57) ABSTRACT

The subject matter of this specification generally relates to computer security. In some implementations, a computing device detects a request to generate data for an encryption key at the computing device. The computing device identifies a process that initiated the request. The computing device determines, based at least on one or more characteristics of the process that initiated the request, whether or not to store a copy of the data for the encryption key. In response to determining to store the copy of the data for the encryption key, the computing device stores the copy of the data for the encryption key.

### TECHNICAL FIELD

This disclosure generally relates to computer security.

### BACKGROUND

Computers and data communication networks are often subjected to intrusion attacks, such as ransomware. Ransomware is an increasingly common threat that prevents users from accessing their data until a ransom is paid. A common type of ransomware encrypts a user's files and holds the files for ransom.

### SUMMARY

This specification describes systems, methods, devices, and techniques for recovering from ransomware attacks by selectively storing keys used by ransomware to encrypt files.

In general, one innovative aspect of the subject matter described in this specification can be implemented in a computing device that includes a data processing apparatus and a computer storage medium encoded with a computer program. The program includes data processing apparatus instructions that when executed by the data processing apparatus cause the data processing apparatus to perform operations that include detecting a request to generate data for an encryption key at the computing device, identifying a process that initiated the request, determining, based at least on one or more characteristics of the process that initiated the request, whether or not to store a copy of the data for the encryption key, and in response to determining to store the copy of the data for the encryption key, storing the copy of the data for the encryption key. Other embodiments of this aspect include corresponding methods, systems, apparatus, and computer programs, configured to perform the actions of the methods, encoded on computer storage devices.

These and other implementations can optionally include one or more of the following features. In some aspects, the one or more characteristics of the process include at least one of (i) a period of time for which an executable file for an application that initiated the process has been stored on the computing device or (ii) whether the executable file is a signed file. The one or more characteristics of the process can include data identifying an entity that signed the file.

In some aspects, storing the copy of the data for the encryption key can include storing the copy of the data for the encryption key in a data storage location inaccessible to an application that initiated the process. The data storage location can include at least one of a key escrow service that is remote from the computing device or hardware-backed secure storage of the computing device.

In some aspects, the operations include determining a period of time for which to store the copy of the data for the encryption key based on the one or more characteristics of the process.

In some aspects, the operations include detecting a second request to generate data for a second encryption key at the computing device, identifying a second process that initiated the second request, and determining, based at least on one or more characteristics of the second process that initiated the second request, whether or not to store the second copy of the data for the second encryption key and, in response, deleting the second copy of the data for the second encryption key.

In some aspects, the operations include identifying an application that initiated the process, monitoring behavior of the application after identifying the application that initiated the process, and determining, based on the monitored behavior, whether or not to delete the copy of the data for the encryption key. The monitored behavior of the application can include at least one of (i) a number of files encrypted by the application or (ii) types of files encrypted by the application.

In some aspects, the data for the encryption key can include either the encryption key or random data for generating the encryption key.

Particular embodiments of the subject matter described in this specification can be implemented so as to realize one or more of the following advantages. Data for encryption keys (e.g., encryption keys or random data used to generate encryption keys) that are likely to be associated with ransomware can be stored in a secure location so that the data can be used to recover files encrypted using the keys. By storing the encryption data in a secure location, the ransomware cannot encrypt the encryption data and the encryption data can be used to recover files encrypted by the ransomware.

By selectively determining whether or not to store encryption data based on one or more characteristics of a process for which the encryption data was generated, encryption data for processes that are not likely to be ransomware can be discarded. This prevents the storage of encryption data for trusted or safe processes at a user device where unauthorized processes can gain access to the data and use the data to recover secure data, while storing encryption data for suspicious processes that are more likely to be ransomware. Encryption data generated for a suspicious process can be stored temporarily until the process is deemed trusted, e.g., based on the behavior of the process. Once deemed trusted, the encryption data generated for the process can be discarded to protect the security of data encrypted by the process.

Selectively storing encryption data rather than storing all encryption data reduces the amount of memory consumed by the encryption data. When the encryption data is stored remotely, the amount of network traffic used to transmit the encryption data is also reduced by selectively storing encryption data rather than storing all encryption data. This can result in faster transmission speeds, more network bandwidth, and less demand placed on networking resources.

Various features and advantages of the foregoing subject matter is described below with respect to the figures. Additional features and advantages are apparent from the subject matter described herein and the claims.

### DESCRIPTION OF DRAWINGS

FIG. 1 depicts an example environment in which a data security application selectively stores data for encryption keys.

FIG. 2 depicts a flowchart of an example process for determining whether or not to store data for an encryption key and either storing or deleting the encryption data based on the determination.

FIG. 3 depicts a flowchart of an example process for recovering files encrypted by ransomware.

FIG. 4 depicts a flowchart of an example process for determining whether or not to keep storing data for an encryption key and either keep storing the data for the encryption key or delete the data for the encryption key.

Like reference numbers and designations in the various drawings indicate like elements.

### DETAILED DESCRIPTION

In general, this disclosure describes systems, methods, devices, and techniques for recovering from ransomware attacks by selectively storing data for encryption keys used by ransomware to encrypt files. The data for the encryption keys (“encryption data”) can include an encryption key or random data that is used to generate the encryption key. A data security application running on a user device can selectively store copies of encryption data based on the process that initiated the request for the encryption key. This allows trusted processes to not have vital encryption data stored at the user device or in an escrow service, while storing encryption data generated for processes that are more likely to be ransomware. Stored encryption data for ransomware can then be used to help recover any files encrypted by the ransomware.

Some ransomware uses the cryptography libraries of operating systems to generate encryption keys to encrypt users' files and hold them for ransom. The data security application can detect when the libraries are used to generate an encryption key, identify the process that initiated the request for the encryption key, and obtain a copy of the encryption data. In some implementations, the data security application can wrap or insert a shim into the cryptography libraries. The wrapping or shim can intercept API calls to the library to obtain the encryption data and identify the process that initiated the request for the encryption data.

The data security application can determine whether or not to store the copy of the encryption data based on characteristics of the process that initiated the request for the encryption data. The characteristics can include a period of time for which an executable file for the process has been stored on the user device, whether the executable file is a signed file, and/or whether the file is signed by a trusted source. For example, newly stored files that are not signed and that request encryption data are more likely to be ransomware. Thus, the encryption data for these processes can be stored temporarily, e.g., based on a specified time period or until the process is deemed to be a trusted process. The characteristics of the process can also be used to determine a period of time for which the encryption data will be stored.

The data security application can also use the behavior of the application to determine whether and for how long to store the encryption data. For example, if a process has encrypted at least a specified number of files and/or particular types of files, the data security application can decide to keep storing the encryption data generated for the process. If the number of files encrypted by the process does not meet the threshold or the process has not encrypted the particular types of files, the data security application can delete the encryption data generated for the process.

The encryption data that is to be stored can be stored in a secure location inaccessible by the process for which the encryption data is generated to prevent the process from encrypting the encryption data. For example, the encryption data can be stored at a key escrow service that is remote from the user device or in hardware-backed secure storage of the user device.

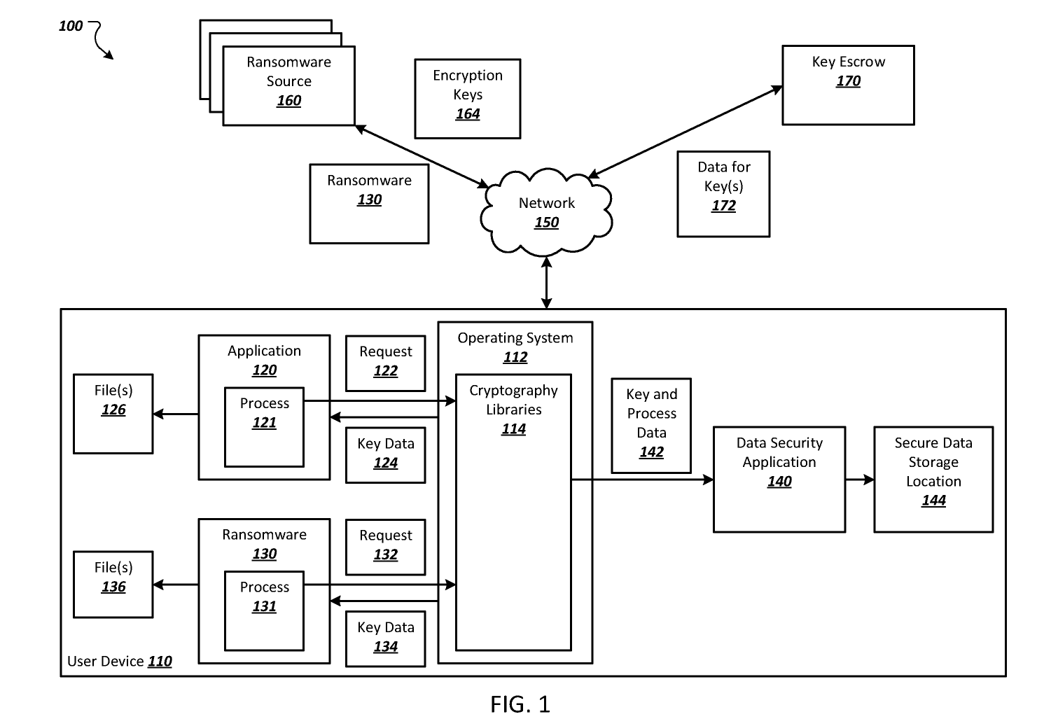

FIG. 1 depicts an example environment 100 in which a data security application 140 selectively stores data for encryption keys. The example data security application 140 is installed on a user device 110. The user device 110 can be a computing device, such as a laptop computer, a desktop computer, a tablet computer, a smartphone, a wearable device, a gaming console, a smart television, or another appropriate device that can store files or other data that can be encrypted.

The user device 110 includes an operating system 112 that manages the user device's hardware and software. The operating system 112 includes one or more cryptography libraries 114 that can be used to generate encryption data, e.g., encryption keys themselves or random data that can be used to generate the encryption keys. For example, some operating systems include a cryptography Application Programming Interface (API) that enable applications and processes to encrypt data. The cryptography API can include one or more cryptography libraries 114 (e.g., in the form of dynamic linked libraries).

As generating random data that can be used to generate encryption keys is difficult, some normal (e.g. trusted) applications and ransomware use the operating system's cryptography libraries 114 to generate encryption data. An application can initiate a process to request encryption data from the cryptography libraries by initiating an API call to the cryptography libraries 114. For example, a trusted application 120 can initiate a process 121 to submit a request 122 (e.g., in the form of an API call) for encryption data to the cryptography libraries 114. In response, the cryptography libraries 114 can generate and return encryption data 124 to the application 120. Similarly, ransomware 130 can initiate a process 131 to submit a request 132 (e.g., in the form of an API call) for encryption data to the cryptography libraries 114. In response, the cryptography libraries 114 can generate and return encryption data 134 to the ransomware 130. The ransomware 130 can then encrypt files stored on the user device 110 and hold the files for ransom.

In cases in which the encryption data is random data, the application 120 or the ransomware 130 can generate an encryption key using the random data. For example, some computer cryptography uses integers for keys. The operating system can generate the integers randomly, e.g., using system entropy such as mouse movements, hard disk timing, or other appropriate random events.

In some implementations, the application 120 and/or the ransomware 130 provide the data (or the location of the data in memory) to be encrypted with the request 122 or 132. In this example the cryptography libraries 114 generate the encryption data and encrypt the data in (or identified by) the request. In some implementations, the application 120 and/or the ransomware 130 use the encryption data 124 or 134 to encrypt data. For example, the application 120 can use the encryption data 124 to encrypt data files 126 and the ransomware 130 can use the encryption data 134 to encrypt the data files 136.

The ransomware 130 may also transmit encryption keys 164 generated for the ransomware 130 back to a source 160 of the ransomware 130 over a data communication network 150, e.g., a local area network (LAN), a wide area network (WAN), a mobile network, the Internet, or a combination thereof. For example, the ransomware 130 may transmit the encryption keys 164 to a computer of the ransomware source 160. The ransomware source 160 may be a person, organization, or other entity that distributes ransomware in order to receive compensation for releasing files encrypted by the ransomware. Having the encryption keys 164 transmitted to the ransomware source 160 allows the ransomware source 160 to hold the encrypted files 136 ransom. If the user of the user device 110 pays the ransom, the ransomware source 160 will typically provide the encryption keys 164 to the user to decrypt the files 136.

To preserve encryption data 134 generated for ransomware, e.g., the ransomware 130, the data security application 142 can use code to intercept requests (e.g., API calls) submitted to the cryptography libraries and obtain a copy of the encryption data generated by the cryptography libraries 114. In some implementations, the data security application 140 can use a shim to intercept the requests and obtain the encryption data. A shim is a library that intercepts API calls and either handles the operation of the API call or redirects the API call somewhere else. The data security application 140 can use shims to intercept each request sent to the cryptography libraries 114, make a call to the cryptography libraries 114 on behalf of the request, receive data returned from the cryptography libraries 114, and return the data to the process that initiated the request. The shim can also include functions that send data identifying the process from the intercepted call and encryption data returned by the cryptography libraries 114 to the data security application 140. In this way, the data security application 140 can receive process data 142 that includes data related to the process that initiated the request (e.g., the identity of the process) and the encryption data generated in response to the request. In some implementations, the data security application 140 wraps the cryptography libraries 114 and/or its API, e.g., using a wrapper class, to obtain the key and process data 142 in a similar manner.

In some implementations, the shim or wrapper can detect processes running in the operating system's kernel and identify the file that initiated the request. As the number of processes running in the kernel should be minimal, this allows the shim to identify the process and file that initiated the request for encryption data. The data security application 140 can then obtain the file and/or its metadata for further analysis.

The data security application 140 can determine whether to store a copy of the encryption data generated by the cryptography libraries 114 based on the process for which the encryption data was generated. For example, the data security application 142 can determine whether to store the copy of the encryption data based on one or more characteristics of the process.

The characteristics of the process can include a period of time for which a file, e.g., an executable file, for an application that initiated the process has been stored on the user device 110. For example, older files that have been used by the user device 110 over a long period of time are less likely to be ransomware than newer files. In this example, the data security application 140 can identify the executable file for the application based on data identifying the process that initiated the request for the encryption data. The data security application 140 can identify a date and time at which the executable file was saved to the user device 110, e.g., based on metadata of the executable file. The data security application 140 can determine whether the executable file has been stored at the user device for at least a threshold period of time, e.g., twenty minutes, a day, a week, or some other appropriate threshold period of time. If so, the data security application 140 can delete the copy of the encryption data for the process as the process is less likely to be related to ransomware than a newer file. If not, the data security application 140 can store the encryption data for the process.

The characteristics of the process can include a number of times the process has been performed at the user device 110 or the number of times the executable file for the process has been executed by the user device 110. For example, if the process has been performed at least a threshold number of times (e.g., five, ten, fifty, or another appropriate number of times) or the executable file has been executed at least the threshold number of times, the data security application 140 can determine that the process is trusted and delete the copy of the encryption data for the process. If the process has not been performed at least the threshold number of times, or the executable file has not been executed at least the threshold number of times, the data security application 140 can store the copy of the encryption data for the process.

The characteristics of the process can include whether or not a file, e.g., an executable file, for an application that initiated the process is signed. If the file is signed by a trusted source, e.g., a source included in a whitelist of trusted sources, the data security application 140 can delete the copy of the encryption data for the process. For example, a process initiated by a file signed by a trusted source is less likely to be ransomware than a process initiated by an unsigned file or a file signed by an unknown source or a source that is not trusted. If the file is not signed or signed by an unknown source or a source that is not trusted, the data security application 140 can store the copy of the encryption data for the process.

Some ransomware has encryption data generated for each file that the ransomware intends to encrypt. In such cases, if the data security application 140 has determined to store a copy of the encryption data for a process initiated by an application, the data security application 140 can then store encryption data for each subsequent process initiated by the application that requests encryption data from the cryptography libraries 114.

The characteristics of the process can include behavior of the process or behavior of an application that initiated the process. For example, if the process is initiated by an application for which the file has not been stored on the user device 110 for at least a threshold period of time or the file is not signed by a trusted source, the data security application 140 can store a copy of the encryption data for the process. If processes initiated by the application do not request encryption data at least a threshold number of times over a specified time period, the data security application 140 can determine that processes initiated by the application are trusted and delete the previously stored encryption data for the process(es) initiated by the application. In another example, the data security application 140 can monitor the number of files encrypted by a process or application. If the number of files exceeds a threshold number of files, the data security application 140 can determine to keep storing the copy of the encryption data for the process or application. If not, the data security application 140 can delete the copy of the encryption data for the process or application.

In yet another example, the data security application 140 can identify the types of files encrypted by a process or application. If the types of files correspond to one of a particular set of file types, e.g., documents, images, etc., the data security application 140 can determine to keep storing the copy of the encryption data for the process or application. The data security application 140 can also disable the process or application, e.g., by removing the executable file, uninstalling the application that initiated the process, or some other appropriate way. If the process or application does not encrypt files of the particular set of file types, the data security application 140 can delete the encryption data for the process or application.

In some implementations, the data security application 140 can evaluate a process that requested encryption data to determine whether the process is a new process for the user device 110. For example, the data security application 140 can compare data about a process (e.g., the name of the application or its executable file, data included in an API call initiated by the process, etc.) to data about known processes. If the process is new, e.g., the process has not been detected at the user device 110 before, the data security application 140 can store a copy of encryption data for the process. The data security application 140 can also send the data about the process to a data security or antivirus service, e.g., a third party data security or antivirus service. This service can maintain data about processes detected at multiple user devices and use this data to determine whether a process detected at the user device 110 is new, trusted (e.g., included in a list of trusted processes), or known to be malicious (e.g., included in a list of malicious processes). For example, if the process has been detected on fewer than a threshold number of user devices (e.g., fewer than 50, 100, 1,000, or another appropriate number of user devices), the service can determine that the process is new. In another example, if the process was first detected within a threshold period of time (e.g., within the last hour, week, month, etc.) at any of the user devices that use the service, the service can determine that the process is new. The service can then provide this data to the data security application 140. If the process is determined to be new or malicious, the data security application 140 can continue storing the encryption data for the process. If the process is determined to be trusted, the data security application 140 can delete the encryption data for the process.

In some implementations, the data security application 140 can maintain a list of processes and their respective application and/or file for processes that requested encryption data from the cryptography libraries 140. The data security application 140 can also store copies of encryption data for the processes. Periodically, the data security application 140 can send the data for the processes to the service with a request for information specifying whether each process is new, trusted, or malicious. For example, the data security application 140 can send the request each hour, each day, each week, based on another time period, or based on a number of processes that have requested encryption data. The data security application 140 can store copies of the encryption data generated for processes that are identified as being new or malicious. The data security application 140 can delete copies of the encryption data for processes identified as being trusted or not new.

The data security application 140 can use any combination of the characteristics described above to determine whether or not to store a copy of encryption data for a process. For example, the data security application 140 can determine a trust score for a process based on each of one or more of the characteristics described above, e.g., by determining an individual score for each of the characteristics based on whether the characteristic satisfies the requirements described above and then combining, e.g., adding, the individual scores to determine the trust score. If the trust score satisfies a threshold (e.g., by meeting or exceeding the threshold), the data security application 140 can delete the copy of the encryption data for the process. If the trust score does not exceed the threshold, the data security application 140 can store the copy of the encryption data for the process.

For copies of encryption data that the data security application 140 determines to store, the data security application 140 can store the copies of the encryption data in a secure data storage location 144 on the user device 110 or send the encryption data to a key escrow service 170 remote from and/or across the network 150 from the user device 110. The secure storage area of the user device 110 can be a hardware-backed secure storage area of the user device 110, the kernel of the operating system 112, or in another data storage location that is inaccessible by the ransomware 130. The key escrow service 170 can be a server, data center, or other data storage system that securely stores encryption data for one or more user devices. By storing the encryption data in a secure data storage location 144 or at a key escrow service 170 inaccessible by the ransomware, the ransomware 130 will not be able to encrypt the encryption data. In some implementations, the data security application 140 encrypts the encryption data that is or will be stored in the secure data storage location 144 or at a key escrow service 170.

In some implementations, the data security application 140 can determine how long to store copies of encryption data based on one or more characteristics of the process. For example, if a process is known to be trusted, e.g., because the process or its application is included in a list of trusted processes or trusted applications, the data security application 140 can delete the copy of the encryption data for the process immediately or within a short period of time (e.g., within five seconds after identifying the process or application as trusted). If the data security application is confident that the process is ransomware (e.g., based on the trust score described above, based on the number or types of files encrypted by the process or its application, or based on data received from a third party service), the data security application 140 can store the copy of the encryption data for the process indefinitely or until the threat imposed by the process is eliminated and any files encrypted by the process are recovered.

If the process is not determined to be trusted and the data security application 140 is not confident the process is ransomware, the data security application 140 can store the copy of the encryption data for the process and monitor the behavior of the process or its application, as described above. The data security application 140 can then determine, based on the monitored behavior, whether to keep storing the copy of the encryption data or delete the copy of the encryption data.

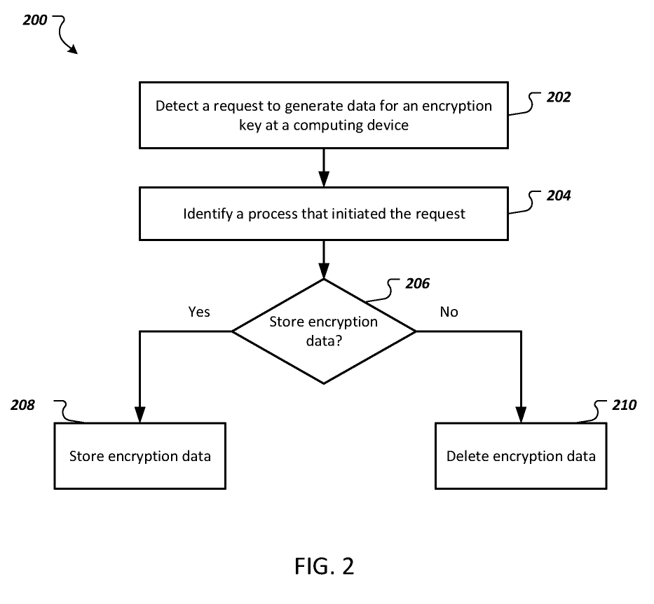

FIG. 2 depicts a flowchart of an example process 200 for determining whether or not to store data for an encryption key and either storing or deleting the encryption data based on the determination. Operations of the process 200 can be implemented, for example, by a system that includes one or more data processing apparatus, such as the user device 110 of FIG. 1. The process 200 can also be implemented by instructions stored on a computer storage medium where execution of the instructions by a system that includes a data processing apparatus cause the data processing apparatus to perform the operations of the process 200.

The system detects a request to generate data for an encryption key at a computing device (202). The system can detect the request by inserting a shim in a cryptography library of the computing device's operating system or by wrapping the cryptography library. The shim or wrapping can intercept requests (e.g., API calls) sent to the cryptography library and obtain data from the requests, such as data identifying a process that initiated the request. For example, the shim or wrapping can intercept functions such as “GetKey( )” functions that request encryption keys or “GetRandomData( ) functions that request random data for use in generating encryption keys.

The system identifies a process that initiated the request (204). For example, the system can receive the data obtained by the shim or wrapping, including the data identifying the process that initiated the request.

The system determines whether to store a copy of encryption data generated in response to the request (206). The system can determine whether to store the copy of the encryption data based on one or more characteristics of the process. As described above, the characteristics of the process can include one or more of a period of time for which a file, e.g., an executable file, for an application that initiated the process has been stored on the computing device, a number of times the process has been performed at the computing device, the number of times the executable file for the process has been executed by the computing device, whether or not a file, e.g., the executable file, for an application that initiated the process is signed, the behavior of the process or its application, and/or other appropriate characteristics. The system can use one of the characteristics or a combination of two or more of the characteristics to determine whether to store the copy of the encryption data.

If the system determines to store the encryption data, the system stores the encryption data (208). The system can store the encryption data in a data storage location that is inaccessible to ransomware. For example, the system can store the encryption data in hardware-backed secure storage area of the computing device, the kernel of the computing device's operating system, at a key escrow service, or in another data storage location that is inaccessible by ransomware on the computing device.

If the system determines to not store the encryption data, the system can delete the encryption data (210). In some implementations, the system can discard the encryption data in such a way that the data cannot be recovered, e.g., by writing over the encryption data with other data.

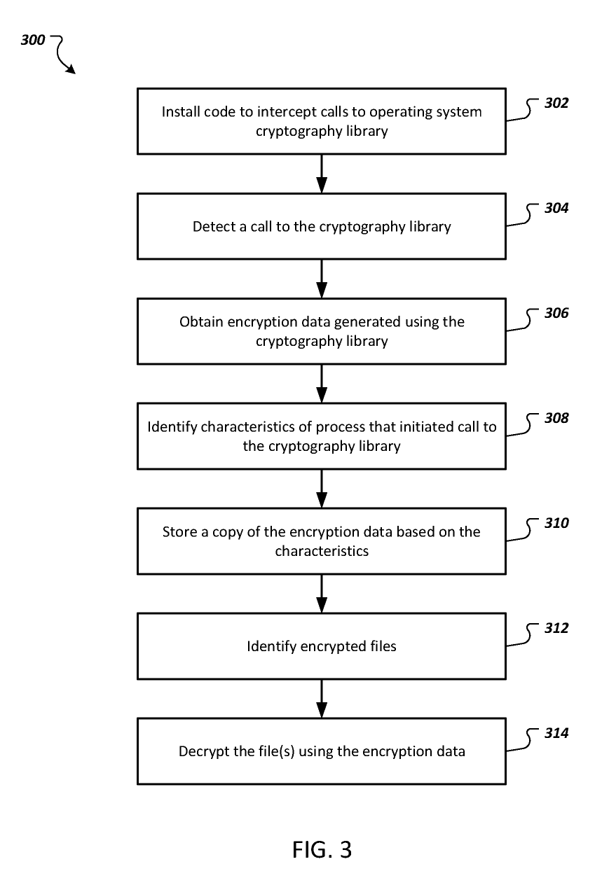

FIG. 3 depicts a flowchart of an example process 300 for recovering files encrypted by ransomware. Operations of the process 300 can be implemented, for example, by a system that includes one or more data processing apparatus, such as the user device 110 of FIG. 1. The process 300 can also be implemented by instructions stored on a computer storage medium where execution of the instructions by a system that includes a data processing apparatus cause the data processing apparatus to perform the operations of the process 300.

The system installs code to intercept calls to an operating system's cryptography library (302). For example, the system can install a shim or wrapping to the cryptography library of the system's operating system to intercept calls to the cryptography library.

The system detects a call to the cryptography library (304). The shim or wrapping can intercept a call to the cryptography library and provide data about the call to the system. For example, the shim or wrapping can intercept the call, make the call to the operating system on behalf of the process, receive the encryption data generated by the operating system's cryptography library, and return the encryption data to the application that initiated the process.

The system obtains data for an encryption key generated using the cryptography library (306). For example, the shim or wrapping can also include functions that obtain data identifying the process from the call and the encryption data received from the operating system's cryptography library and provide the data to the system.

The system identifies one or more characteristics of the process that initiated the call to the cryptography library (308). The one or more characteristics can include one or more of a period of time for which a file, e.g., an executable file, for an application that initiated the process has been stored on the computing device, a number of times the process has been performed at the computing device, the number of times the executable file for the process has been executed by the computing device, whether or not a file, e.g., the executable file, for an application that initiated the process is signed, the behavior of the process or its application, and/or other appropriate characteristics.

The system stores the copy of the encryption data based on the one or more characteristics (310). For example, the system can determine that the process is suspicious based on the one or more characteristics and, in response, store the copy of the encryption data, as described above. In a particular example, the system can determine that the process was initiated by a file that has not been stored on the computing device for at least a threshold period of time and, in response, determine to store the copy of the encryption data. In another example, the system can determine that the process was initiated by an unsigned file that has not been stored on the computing device for at least a threshold period of time and, in response, determine to store the copy of the encryption data.

The system identifies one or more files that have been encrypted using the encryption data, by the process, and/or by an application that initiated the process after the encryption data has been stored (312). In some implementations, the system can monitor the process or its application in response to determining to store the copy of the encryption data. For example, the system can monitor processes initiated by the application to detect whether the application is encrypting any files, and if so, identify the files that are being encrypted by the application's processes.

The system decrypts the files using the stored copy of the encryption data (314). If the copy of the encryption data includes the encryption key itself, the system can use the encryption key to decrypt the files. If the encryption data is the random data used to generate the encryption key, the encryption key can be generated using the random data. However, this may require some additional processing to generate the encryption key. For example, some ransomware may alter the random data to make generating the encryption key difficult. The system, or a user of the system, may have to decode the random data before generating an encryption key using the random data. Decoding the random data is typically a deterministic process, but may require additional processing.

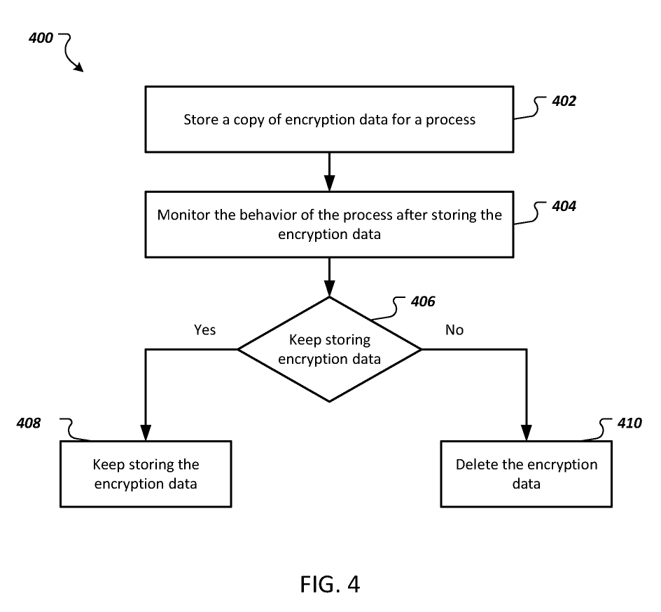

FIG. 4 depicts a flowchart of an example process 400 for determining whether or not to keep storing data for an encryption key and either keep storing the data for the encryption key or delete the data for the encryption key. Operations of the process 400 can be implemented, for example, by a system that includes one or more data processing apparatus, such as the user device 110 of FIG. 1. The process 400 can also be implemented by instructions stored on a computer storage medium where execution of the instructions by a system that includes a data processing apparatus cause the data processing apparatus to perform the operations of the process 400.

The system stores encryption data for a process (402). For example, the system can store the encryption data in response to determining that the process is suspicious, e.g., based on one or more characteristics of the process.

The system monitors the behavior of the process and/or the application that initiated the process (404). The system can monitor the process and/or its application to detect the encryption of files by the process or application. The system can determine, based on the monitoring, the number of files encrypted by the process or application and/or the types of files encrypted.

The system determines whether or not to keep storing the encryption data based on the monitored behavior (406). For example, the system can determine whether to keep storing the encryption data based on the number of files encrypted and/or the types of files encrypted. If the number of files exceeds a threshold number of files, the system can determine to keep storing the copy of the encryption data. If the number of files does not exceed the threshold number of files, the system can determine to delete the copy of the encryption data.

In another example, if the types of files encrypted by the process or application correspond to one of a particular set of file types, e.g., documents, images, etc., the system can determine to keep storing the copy of the encryption data. If neither of the types of files encrypted by the process or application correspond to at least one of the particular set of file types, the system can determine to delete the encryption data for the process or application.

If the system determines to keep storing the copy of the encryption data, the system keeps storing the encryption data (408). The system can also keep monitoring the process and/or application, e.g., by returning to operation (404).

If the system determines to not keep storing the encryption data, the system deletes the copy of the encryption data (410).

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computing device, comprising:
a data processing apparatus; and
a computer storage medium encoded with a computer program, the program comprising data processing apparatus instructions that when executed by the data processing apparatus cause the data processing apparatus to perform operations comprising:
detecting a request to generate data for an encryption key at the computing device;
identifying a process that initiated the request;
determining, based at least on one or more characteristics of the process that initiated the request, whether or not to store a copy of the data for the encryption key; and
in response to determining to store the copy of the data for the encryption key, storing the copy of the data for the encryption key.

2. The computing device of claim 1, wherein the one or more characteristics of the process comprise at least one of (i) a period of time for which an executable file for an application that initiated the process has been stored on the computing device or (ii) whether the executable file is a signed file.

3. The computing device of claim 2, wherein the one or more characteristics of the process comprise data identifying an entity that signed the file.

4. The computing device of claim 1, wherein storing the copy of the data for the encryption key comprises storing the copy of the data for the encryption key in a data storage location inaccessible to an application that initiated the process.

5. The computing device of claim 4, wherein the data storage location comprises at least one of a key escrow service that is remote from the computing device or hardware-backed secure storage of the computing device.

6. The computing device of claim 1, wherein the operations comprise determining a period of time for which to store the copy of the data for the encryption key based on the one or more characteristics of the process.

7. The computing device of claim 1, wherein the operations comprise:
detecting a second request to generate data for a second encryption key at the computing device;
identifying a second process that initiated the second request; and
determining, based at least on one or more characteristics of the second process that initiated the second request, whether or not to store the second copy of the data for the second encryption key and, in response, deleting the second copy of the data for the second encryption key.

8. The computing device of claim 1, wherein the operations comprise:
identifying an application that initiated the process;
monitoring behavior of the application after identifying the application that initiated the process; and
determining, based on the monitored behavior, whether or not to delete the copy of the data for the encryption key.

9. The computing device of claim 8, wherein the monitored behavior of the application includes at least one of (i) a number of files encrypted by the application or (ii) types of files encrypted by the application.

10. The computing device of claim 1, wherein the data for the encryption key comprises either the encryption key or random data for generating the encryption key.

11. A computer-implemented method, comprising:
detecting a request to generate data for an encryption key at a computing device;
identifying a process that initiated the request;
determining, based at least on one or more characteristics of the process that initiated the request, whether or not to store a copy of the data for the encryption key; and
in response to determining to store the copy of the data for the encryption key, storing the copy of the data for the encryption key.

12. The method of claim 11, wherein the one or more characteristics of the process comprise at least one of (i) a period of time for which an executable file for an application that initiated the process has been stored on the computing device or (ii) whether the executable file is a signed file.

13. The method of claim 12, wherein the one or more characteristics of the process comprise data identifying an entity that signed the file.

14. The method of claim 11, wherein storing the copy of the data for the encryption key comprises storing the copy of the data for the encryption key in a data storage location inaccessible to an application that initiated the process.

15. The method of claim 14, wherein the data storage location comprises at least one of a key escrow service that is remote from the computing device or hardware-backed secure storage of the computing device.

16. The method of claim 11, wherein the operations comprise determining a period of time for which to store the copy of the data for the encryption key based on the one or more characteristics of the process.

17. The method of claim 11, further comprising:
detecting a second request to generate data for a second encryption key at the computing device;
identifying a second process that initiated the second request; and
determining, based at least on one or more characteristics of the second process that initiated the second request, whether or not to store the second copy of the data for the second encryption key and, in response, deleting the second copy of the data for the second encryption key.

18. The method of claim 11, further comprising:
identifying an application that initiated the process;
monitoring behavior of the application after identifying the application that initiated the process; and
determining, based on the monitored behavior, whether or not to delete the copy of the data for the encryption key.

19. The method of claim 18, wherein the monitored behavior of the application includes at least one of (i) a number of files encrypted by the application or (ii) types of files encrypted by the application.

20. A non-transitory computer storage medium encoded with a computer program, the program comprising instructions that when executed by one or more data processing apparatus cause the data processing apparatus to perform operations comprising:
detecting a request to generate data for an encryption key at a computing device;
identifying a process that initiated the request;
determining, based at least on one or more characteristics of the process that initiated the request, whether or not to store a copy of the data for the encryption key; and
in response to determining to store the copy of the data for the encryption key, storing the copy of the data for the encryption key.
